(19) United States
(12) Patent Application Publication
(10) Pub. No.: US 2015/0217869 A1
(43) Pub. Date: Aug. 6, 2015

(54) REMOVABLE STORAGE FOR HYDROGEN ON-BOARD PASSENGER TRANSPORT VEHICLES SUCH AS AIRCRAFT

(71) Applicant: Zodiac Aerotechnics, Plaisir (FR)

(72) Inventors: Yannick Brunaux, Saint Cyr L'Ecole (FR); Vincent Gillotin, Vauhallan (FR); Jerome Cerisier, Meudon (FR)

(73) Assignee: Zodiac Aerotechnics, Plaisir (FR)

(21) Appl. No.: 14/416,168

(22) PCT Filed: Mar. 13, 2013
(86) PCT No.: PCT/IB2013/051984

§ 371 Date: Jan. 21, 2015

Related U.S. Application Data
(60) Provisional application No. 61/675,915, filed on Jul. 26, 2012.

(51) Int. Cl. B64D 37/30; B64D 37/06; B64D 41/00

(52) U.S. Cl. CPC B64D 37/30; B64D 41/00; B64D 37/06; B64D 2041/005

(57) ABSTRACT

Embodiments of the present invention relate generally to removable storage for hydrogen networks on-board an aircraft, aerospace vehicles, or other passenger transport vehicles. They are particularly related to such vehicles that use a hydrogen network in order to support a fuel cell system, more scecifically it discloses an interchangeable hydrogen storage mounted in a trolley or in a cradle for a plane for onboard applications.

### CROSS REFERENCE TO RELATED APPLICATIONS

This application claims the benefit of U.S. Provisional Application Ser. No. 61/675,915, filed Jul. 26, 2012, titled “Removable Storage for Hydrogen Aircraft Network,” the entire contents of which are hereby incorporated by reference.

### FIELD OF THE INVENTION

Embodiments of the present invention relate generally to removable storage for hydrogen networks on-board an aircraft, aerospace vehicles, or other passenger transport vehicles. They are particularly related to such vehicles that use a hydrogen network in order to support a fuel cell system.

### BACKGROUND

A number of components on-board an aircraft require electrical power for their activation. Many of these components are separate from the electrical components that are actually required to run the aircraft (i.e., the navigation system, fuel gauges, flight controls, and hydraulic systems). For example, aircraft also have catering equipment, heating/cooling systems, lavatories, power seats, water heaters, and other components that require power as well. Specific components that may require external power include but are not limited to trash compactors (in galley and/or lavatory), ovens and warming compartments (e.g., steam ovens, convection ovens, bun warmers), optional dish washer, freezer, refrigerator, coffee and espresso makers, water heaters (for tea), air chillers and chilled compartments, galley waste disposal, heated or cooled bar carts/trolleys, surface cleaning, area heaters, cabin ventilation, independent ventilation, area or spot lights (e.g., cabin lights and/or reading lights for passenger seats), water supply, water line heating to prevent freezing, charging stations for passenger electronics, electrical sockets, vacuum generators, vacuum toilet assemblies, grey water interface valves, power seats (e.g., especially for business or first class seats), passenger entertainment units, emergency lighting, and combinations thereof. These components are important for passenger comfort and satisfaction, and many components are absolute necessities.

However, one concern with these components is their energy consumption. As discussed, galley systems for heating and cooling are among several other systems aboard the craft which simultaneously require power. Frequently, such systems require more power than can be drawn from the aircraft engines' drive generators, necessitating additional power sources, such as a kerosene-burning auxiliary power unit (APU) (or by a ground power unit if the aircraft is not yet in flight). This power consumption can be rather large, particularly for long flights with hundreds of passengers. Additionally, use of aircraft power produces noise and CO₂ emissions, both of which are desirably reduced. Accordingly, it is desirable to identify ways to improve fuel efficiency and power management by providing innovative ways to power these components. There are new ways being developed to generate power to run on-board components, as well as to harness beneficial by-products of that power generation for other uses on-board passenger transport vehicles, such as aircraft.

The relatively new technology of fuel cells provides a promising cleaner and quieter means to supplement energy sources already aboard aircrafts. A fuel cell has several outputs in addition to electrical power, and these other outputs often are not utilized, but can be used to avoid loss of other usable energy sources (such as thermal, electric and/or pneumatic power) generated by the fuel cell system. Fuel cell systems combine a fuel source of compressed hydrogen with oxygen in the air to produce electrical and thermal power as a main product. Water and Oxygen Depleted Air (ODA) are produced as by-products, which are far less harmful than CO₂ emissions from current aircraft power generation processes.

Because the proposed use of fuel cell systems on-board aircraft and other vehicles is relatively new, there are not appropriate storage networks and systems in place for the hydrogen that is required for fuel cell functioning. Specifically, there are currently no hydrogen networks installed on a commercial aircraft. Oxygen networks are installed in case of emergency aircraft depressurization, such that oxygen can be provided for crew and passengers. To avoid high oxygen leakage, an automatic flow fuse can be installed along the gas network. High pressure is avoided out of the cylinder area, and low pressure is preferred for safety reasons. There are also often provided chemical oxygen generators on-board an aircraft or aerospace vehicle. However, these systems and networks are not designed to be removable, nor are they designed for delivering gas to a fuel cell system, but for delivering oxygen to breathing systems and other pressurized systems.

Accordingly, there is a current need for a removable hydrogen storage system that can be removed and refilled and/or exchanged.

### BRIEF SUMMARY

Embodiments of the invention described herein thus provide hydrogen storage for an aircraft network that is used for fuel cell application and/or any other hydrogen application. The hydrogen storage solutions are designed to be removable from the vehicle, such that they can be refilled and/or exchanged for a new source of hydrogen.

### BRIEF DESCRIPTION OF THE DRAWINGS

FIG. 1 shows a side plan view of a hydrogen storage trolley.

FIG. 2 shows a side plan view of a hydrogen storage cradle.

FIG. 3 shows a side perspective view of a hydrogen storage air cargo container.

FIG. 4 shows a schematic of a potential hydrogen aircraft network.

FIG. 5 illustrates a schematic of a fuel cell system that uses hydrogen.

FIG. 6 illustrates a schematic of how a fuel cell system may be used to power various aircraft systems.

FIG. 7 illustrates one embodiment of a cylindrical quick fit connector that may be used to connect the hydrogen to one or more aircraft systems.

FIG. 8 illustrates one embodiment of a quick fit connector (plate) that may be used to connect the hydrogen to one or more aircraft systems.

### DETAILED DESCRIPTION

Embodiments of the present invention provide devices, systems, and methods for providing removable hydrogen storage in an aircraft or other passenger transport vehicle. The systems are designed to be easily removable from the vehicle and replaced with a new set of hydrogen tanks. Airlines seek more and more to reduce turn-around time of the aircraft, but it is also imperative for solutions to be safe to install, as well as safe and easy maintain. It desirable that the embodiments described herein be quick to fit and remove from the vehicle, so that the hydrogen filling can take place off-site or in another dedicated safe filling area. This means that there will not be increased aircraft turn-around time or additional safety precautions or consideration to implement for hydrogen filling purposes. The solutions described are thus intrinsically safe and easily available, while also being easy to integrate, reducing logistics. The various embodiments described herein may be used individually or in conjunction with one another and other commercial solutions. There may be provided one or more hydrogen storage locations. It should also be understood that although the systems are described with respect to use of hydrogen for the fuel cell systems, the removable hydrogen storage described is not dedicated to a specific application and the concept of decentralized storage of this type of fuel (or other types of fuel) may be used to power other aircraft applications.

Hydrogen gas networks compare to oxygen gas networks in that they both require establishment of safety regulations and standards. Any gas cylinder installed onboard an aircraft must be qualified, certified, and obtain DOT approval. The guideline SAE AIR6464 provides recommendations for aircraft fuel cell system integration.

Gas storage used for hydrogen is a typical gas cylinder, having a pressure ranging from about 127 bar to about 700 bar or more. There are different types of gas cylinders, such as Type 1 (metal), Type 2 (Hoop wrapped composite with metal line), Type 3 (Fully wrapped composite with a metal liner), and Type 4 (Fully wrapped composite with no metal liner). The embodiments described herein are useful for all types of cylinders, as well as other storage containers that may be used in the future.

It is generally desirable that any storage solution provided for use of hydrogen on-board a passenger transport vehicle is designed to be safe and secure. Accordingly, the following removable hydrogen storage network systems have been developed.

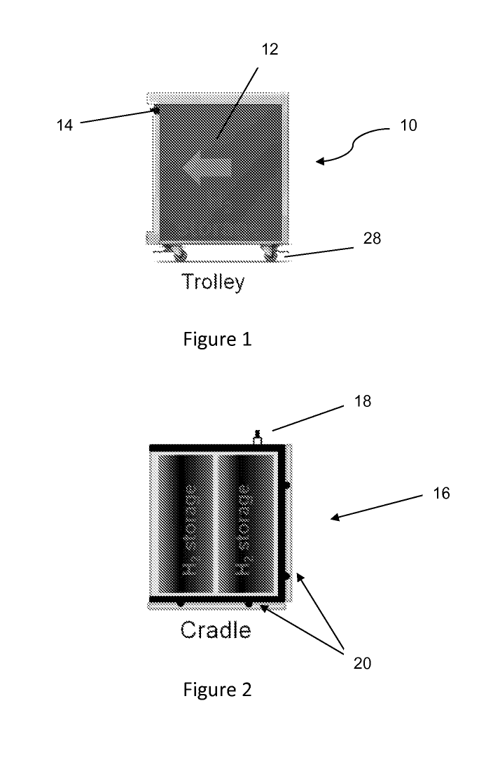

FIG. 1 illustrates a hydrogen storage trolley 10. This trolley 10 is similar to the type of trolley that is normally used for food and/or drink storage and catering on-board an aircraft. In this case, the trolley bay is replaced by a hydrogen storage area 12, which can house one or more cylinders or any other type of storage. A quick plug 14 can be used for hydrogen connection.

In an alternate embodiment, as shown in FIG. 2, the storage may be formed as a cradle 16. Cradle may be plugged to the hydrogen network via a quick fit connection 18 that may be integrated into the cradle 16 for a low standard exchange time. The cradle may be installed in a pressurized or unpressurized area. The cradle has sides and a base, and may have an optional lid/top provided as well. It may be designed in function based on the number of hydrogen cylinders to be housed or based on varying sizes and/or shapes of the hydrogen cylinders. The cradle has a locking strap which can be quickly set to secure the cylinders in place. Other available options for securing the cradle include but are not limited to a locking side rail 20, a docking point, a fixed locking point (such as a classic screw securement), or a quick fit docking feature. These features may also be used with any of the embodiments described herein. The cradle can be removed with standard tooling.

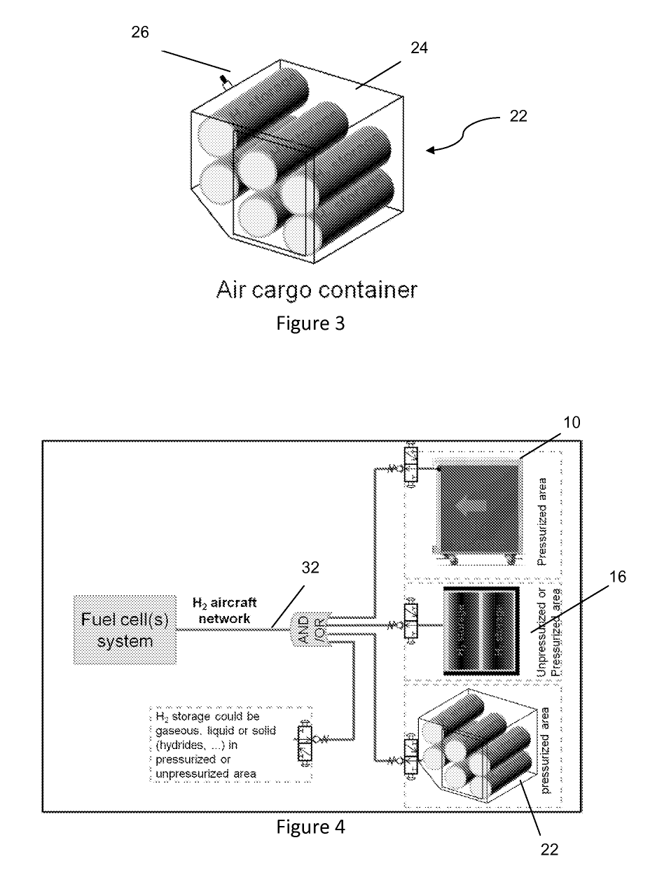

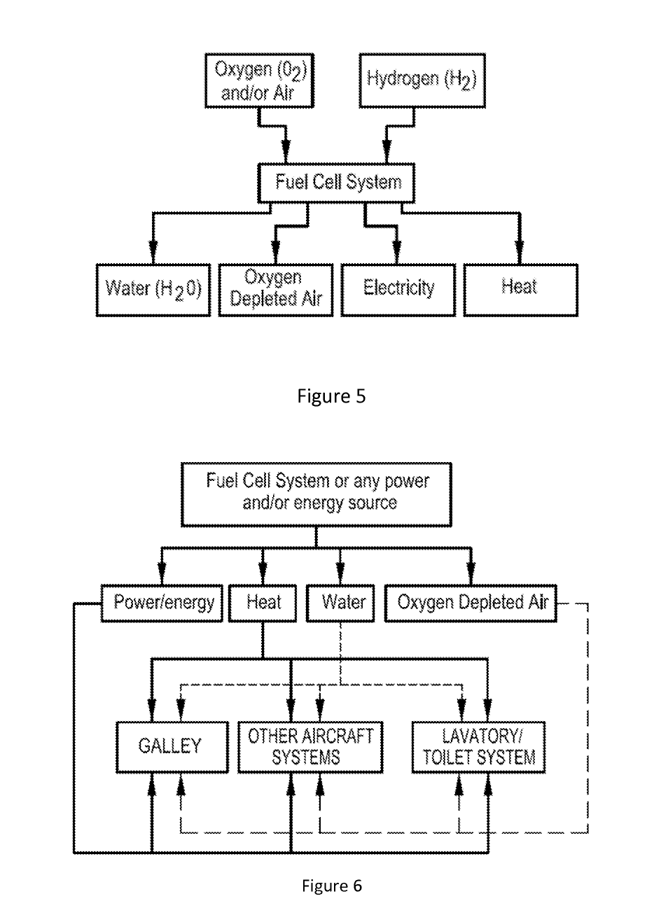

FIG. 3 illustrates a further embodiment, which is an air cargo container 22 embedded with a hydrogen storage area 24. The storage area may be plugged to the hydrogen network via connection port 26. This embodiment may be able to contain a higher quantity of hydrogen than the other two options. Any or all of these options may be used individually or in connection with one another. They are all designed to generally be removable from the aircraft so that the hydrogen cylinders can be removed and refilled at a location remote from the aircraft. Accordingly, these options may be provided with wheels or other movable features, such as the wheels 28 shown on trolley 10, or sliders, or gliders. Alternatively, they may be small enough to be lifted and removed via hand or via a small forklift. In general, a cargo container can be removed and replaced with standard airport handling material, and they have larger storage than some other options. A cargo container is fixed on a slide rail, then is locked with integrated aircraft brackets.

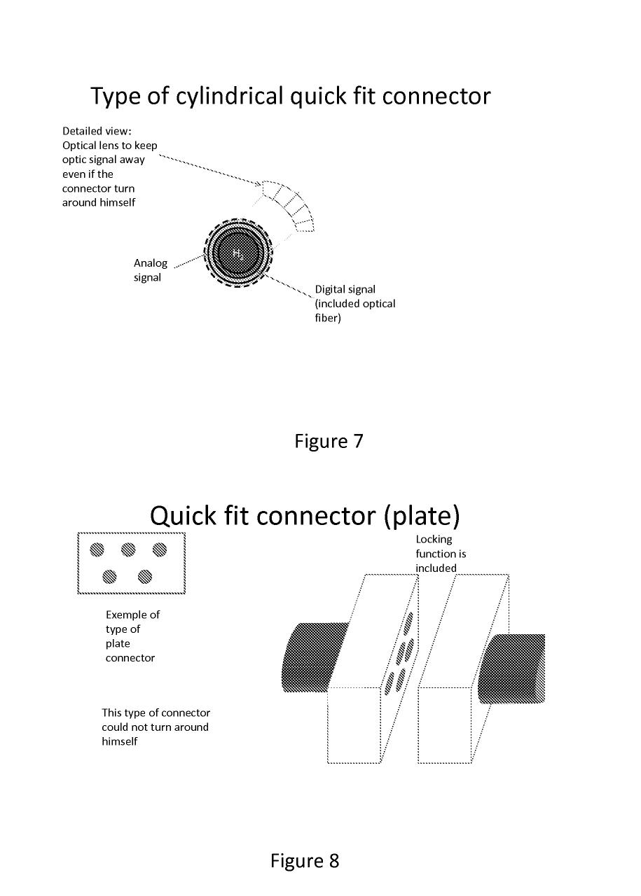

The quick fit plug 14 for the hydrogen storage system may be used on any of these embodiments in order to connect the hydrogen cylinders to the hydrogen network. The plug 14 may integrate a communication cable for A/C communication, or it may use a remote ON/OFF valve. The other connectors 18, 26 may have a quick keyed fit or they may include different sizes in order to avoid unintentional coupling to other components. It may be possible to provide an all-in-one connector or to provide separate connectors that are specific to the hydrogen storage system. FIG. 7 shows one embodiment of a cylindrical quick fit connector, which has an optical lens to keep an optic signal away, even if the connector turns around on itself. FIG. 8 shows one embodiment of a quick fit connector plate, which cannot turn around on itself and which includes a locking function. Other connector are possible and considered within the scope of this invention. It should also be understood that any connector may be used on any of the storage solutions described herein.

In order to start and/or shut off the delivery of hydrogen, manual or remote shut off valves can be installed inside the trolley, cradle, and/or cargo container systems. The system could be closed automatically if one or more of the valves of the trolley, cradle, or cargo container is unintentionally disconnected.

FIG. 4 illustrates a schematic for a hydrogen aircraft network. One or more fuel cell system(s) 30 and/or any other hydrogen application are connected to the hydrogen aircraft network. The network them has conduits 32 that lead to the various storage options 10, 16, and/or 22. These hydrogen storage options can be located in pressurized and/or unpressurized areas of the aircraft. Hydrogen can be stored in gaseous, liquid and/or solid state.

Each storage method can have a quick fit and remove solution, which can be implemented on all types of aircraft and/or can have an intrinsic safety. For example, it is desirable to avoid a permanent H₂ detection, an integrated regulator, and high pressure pipes. Instead, a standalone system is desired for safety purposes. The shut off valve may ne manual, remote, or it may be a standalone shut off valve. As discussed above, the may be a quick keyed fit or it may have a different size from quick key fit connector in order to avoid unintentional coupling.

Changes and modifications, additions and deletions may be made to the structures and methods recited above and shown in the drawings without departing from the scope or spirit of the invention and the following claims.

What is claimed is:

1. A hydrogen storage solution for use on-board an aircraft, comprising:
One or more hydrogen storage features that are configured to be removable from the aircraft; and
A connection feature allowing the hydrogen to be delivered to the systems requiring hydrogen on-board the aircraft.

2. The hydrogen storage solution of claim 1, wherein one of the systems requiring hydrogen is a fuel cell system.

3. The hydrogen storage solution of claim 1, wherein the hydrogen storage comprises a trolley, a cradle, or a cargo bay container.

4. The hydrogen storage solution of claim 1, wherein the hydrogen storage comprises a quick fit connector that connects the hydrogen to an aircraft system.

5. The hydrogen storage solution of claim 4, wherein the quick fit connector comprises a cylindrical quick fir connector or a plate quick fit connector.

6. The hydrogen storage solution of claim 1, wherein the hydrogen storage feature that is removable from the aircraft has a locking system that secures the feature in the aircraft in use.

7. The hydrogen storage solution of claim 6, wherein the locking system comprises a locking strap, a slide rail, a docking point, a screw securement, or a quick fit docking feature.
